(19) United States
(12) Patent Application Publication
(10) Pub. No.: US 2003/0062786 A1
(43) Pub. Date: Apr. 3, 2003

(54) Manufacturing method and composite powder metal rotor assembly for induction machine

(76) Inventors: Frederick B. Reiter JR., Cicero, IN (US); Bradley D. Beard, Yorktown, IN (US); Tom L. Stuart, Pendleton, IN (US)

Correspondence Address: DELPHI TECHNOLOGIES, INC., Legal Staff, P.O. Box 5052, Mail Code: 480-414-420, Troy, MI, 48007-5052, US

(21) Appl. No.: 09/970,197

(22) Filed: Oct. 3, 2001

(51) Int. Cl. H02K 21/12

(52) U.S. Cl. 310/156.08

(57) ABSTRACT

A composite powder metal disk for a rotor assembly in an induction machine. The disk includes a magnetically conducting powder metal segment and a plurality of axially extending slots around the exterior surface of the disk. In each slot is a conductor, for example cast aluminum or copper bars, enclosed within the slot by a magnetically non-conducting powder metal segment. A rotor assembly is also provided having a plurality of the composite powder metal disks mounted axially along a shaft with their magnetic configurations aligned. A method for making the powder metal disks is further provided including filling a die with the powder metals, compacting the powders, and sintering the compacted powders.

### FIELD OF THE INVENTION

This invention relates generally to induction machines, and more particularly, to the manufacture of rotors for an induction machine.

### BACKGROUND OF THE INVENTION

It is to be understood that the present invention relates to generators as well as to motors, however, to simplify the description that follows, a motor will be described with the understanding that the invention also relates to generators. With this understanding, an induction motor is an asynchronous machine having a stator with poly-phase windings forming a plurality of poles and a rotor having the same number of poles as the stator. By providing a rotating field in the stator windings, a magnetomotive force acts upon the rotor resulting in the rotor being driven at an asynchronous speed relative to the rotating field in the stator.

Induction rotors are typically manufactured by stacking a number of stamped, slotted ferromagnetic laminations onto a solid rotor shaft to form a base core assembly, and inserting a conductor into each slot of the core. The conductors are typically aluminum or copper. Aluminum is typically die cast into a die defined about the laminated ferromagnetic core to form integral conductor bars. Aluminum end rings are also cast at each axial end of the rotor assembly. Copper generally does not lend itself to die casting in this manner due to temperature limitations of the ferromagnetic core. Thus, the usual practice in the manufacture of copper bar induction rotors is to attach slotted copper end rings to each axial end of the rotor core and to insert prefabricated copper bars into the slots and braze or weld the ends to the copper rings. The conductor bars either extend to the exterior circumferential surface of the rotor, or reside in slots closed with the same ferromagnetic material as the main portion of the lamination. In either construction, the rotor is subject to high flux leakage through the tooth tip or bridge portions.

The individual stamped ferromagnetic laminations are pressed or shrunk fit onto the shaft. Rotors fabricated from stamped, stacked laminations are structurally weak due to bearing the centrifugal forces of both the ferromagnetic lamination material and the rotor bars. This results in a drastically lower top speed.

There is thus a need to develop an induction machine having the structural support that enables high speeds to be obtained without the flux leakage associated with the conventional high speed induction rotors, and preferably that may be produced at a lower cost than that of a conventional induction motors.

### SUMMARY OF THE INVENTION

The present invention provides a composite powder metal disk for a rotor assembly in an induction machine, the disk comprising a magnetically conducting segment of ferromagnetic powder metal compacted and sintered to high density. The conducting segment includes spaced axially extending slots around the exterior surface of the disk for receiving a conductor. A magnetically non-conducting segment of compacted and sintered non-ferromagnetic powder metal encloses each slot opening adjacent the exterior surface of the disk. In a further embodiment, a rotor assembly is provided having a plurality of the composite powder metal disks axially stacked along and mounted to a shaft. There is further provided a method of making such a composite powder metal disk and rotor assembly in which a die is filled with the powder metals according to the desired magnetic pattern, followed by pressing the powder metal and sintering the compacted powder to achieve a high density composite powder metal disk of high structural stability. These disks are then stacked axially along a shaft with their magnetic patterns aligned to form the powder metal rotor assembly. The conductors may be cast into the aligned slots of the stacked composite disks or may be prefabricated bars inserted into the aligned slots. An induction machine incorporating the powder metal rotor assembly of the present invention can obtain high speeds with low flux leakage, and yet may be produced at a lower cost.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of a powder metal rotor assembly of the present invention having a plurality of disks stacked along a shaft, each having a magnetically conducting segment and a plurality of slots containing conductors enclosed in the slots by magnetically non-conducting segments;

FIG. 2 is a plan view of the assembly of FIG. 1;

FIG. 3 is a plan view of a powder metal rotor assembly of the present invention comprising a ring having a magnetically conducting segment and a large number of slots containing conductors enclosed in the slots by magnetically non-conducting segments;

FIG. 4 is a perspective view of an insert for use in a method of the present invention;

FIG. 5 is a perspective view of an inner bowl and outer bowl of a hopper that may be used for the filling aspect of the present invention;

FIG. 6A-6E are cross-sectional schematic views of a method of the present invention using the insert of FIG. 4 and the hopper of FIG. 5 to produce the rotor assembly of FIGS. 1 and 2;

FIG. 7 is a perspective view of an insert for use in an alternative method of the present invention; and

FIGS. 8A-8C are cross-sectional schematic views of the present invention using the insert of FIG. 7 and the hopper of FIG. 5 to produce the rotor assembly of FIGS. 1 and 2.

### DETAILED DESCRIPTION

The present invention provides composite powder metal rotor components for rotor assemblies in induction machines. Induction machines incorporating the composite powder metal components exhibit low flux leakage with high speed rotating capability. To this end, and in accordance with the present invention, a plurality of powder metal disks or laminations are fabricated to comprise a magnetically conducting segment with a plurality of spaced axially extending slots at the exterior circumferential surface of each disk. A magnetically non-conducting segment encloses a conductor in each slot. The magnetically conducting segment comprises a pressed and sintered soft ferromagnetic powder metal. The magnetically non-conducting segments that enclose the conductors comprise a pressed and sintered non-ferromagnetic powder metal. The conductors enclosed in the slots may comprise a cast metal or a prefabricated metal bar.

In a method of the present invention for forming the composite powder metal rotor components, which method will be described in more detail below, the ferromagnetic and non-ferromagnetic powder metals are filled into a mold, either concurrently or sequentially, to form the desired pattern for the rotor. The powder metals are pressed in the mold and then sintered. The conductors may be formed by casting molten metal into aligned slot openings formed in a stacked plurality of the compacted and sintered powder metal composite disks. Alternatively, the conductors may be prefabricated metal bars inserted into aligned slot openings formed in a stacked plurality of the compacted and sintered powder metal composite disks.

In an embodiment of the present invention, the soft ferromagnetic powder metal of the magnetically conducting segment is nickel, iron, cobalt, or an alloy thereof. In another embodiment of the present invention, this soft ferromagnetic metal is a low carbon steel or a high purity iron powder with a minor addition of phosphorous, such as covered by MPIF (Metal Powder Industry Federation) Standard 35 F-0000, which contains approximately 0.27% phosphorous. In general, AISI 400 series stainless steels are magnetically conducting, and may be used in the present invention for the magnetically conducting segment.

In an embodiment of the present invention, the non-ferromagnetic powder metal of the magnetically non-conducting segments is austenitic stainless steel, such as SS316. In general, the AISI 300 series stainless steels are non-magnetic and may be used in the present invention for the magnetically non-conducting segments. Also, the AISI 8000 series steels are non-magnetic and may be used. In an embodiment of the present invention, the ferromagnetic and non-ferromagnetic materials are chosen so as to have similar densities and sintering temperatures, and are approximately of the same strength, such that upon compaction and sintering, the materials behave in a similar fashion. In an embodiment of the present invention, the soft ferromagnetic powder metal is Fe-0.27%P and the non-ferromagnetic powder metal is SS316.

In an embodiment of the present invention, the conductors comprise aluminum cast into the stacked composite disks together with axial end rings. In another embodiment of the present invention, the conductors are prefabricated copper bars inserted into the slots of stacked composite disks and affixed to axial end rings. In general, the larger the rotor assembly, the more difficult it is to use a casting technique. Thus, for larger machines, copper bars are typically selected. For smaller machines, although copper is a better conductor, casting of aluminum conductors together with aluminum end rings is a much cheaper process. It is well within the ordinary skill of one in the art to select the appropriate conductor for the particular application.

The powder metal disks of the present invention typically exhibit a magnetically conducting segment having at least about 95% of theoretical density, and typically between about 95-98% of theoretical density. Wrought steel or iron has a theoretical density of about 7.85 gms/cm³, and thus, the magnetically conducting segment exhibits a density of around 7.46-7.69 gms/cm³. The non-conducting segments enclosing the conductors exhibit a density of at least about 85% of theoretical density, which is on the order of about 6.7 gms/cm³. Thus, the non-ferromagnetic powder metals are generally less compactible than the ferromagnetic powder metals.

The powder metal disks or rings can essentially be of any thickness. These disks are aligned axially along a shaft and affixed to the shaft to form a rotor assembly. The shaft is typically equipped with a key and the individual disks have a keyway on an interior surface to mount the disks to the shaft upon pressing the part to the shaft. In an embodiment of the present invention, the individual disks or rings have a thickness on the order of about ⅜ to ⅞ inches. As disk thickness increases, the boundaries between the powder metal conducting segment and powder metal non-conducting segments may begin to blur. In practice, up to 13 disks of the present invention having a ⅜-⅞ thickness are suitable for forming a rotor assembly. There is no limit on the number of conductor slots for the rotor assembly. The individual disks are aligned with respect to each other along the shaft such that the conductors and the magnetic flux paths are aligned along the shaft. There is, however, no limit to the thickness of each composite powder metal disk or the number of disks that may be utilized to construct a rotor assembly.

The ferromagnetic material covers all of the cross-section of the induction rotor, except the slots where the conductors are situated and the slot openings which are closed using the non-ferromagnetic material. Due to the bulk of the rotorassembly being fabricated from the ferromagnetic material, the rotor assembly is optimized for minimum overall weight, structural integrity and maximization of rotor current. The electrical conductance of the rotor is enhanced by embedding the conductor segments in the rotor. The non-ferromagnetic material closing the slot openings serves to prevent magnetic flux from passing over the conductor slot opening and to provide a structural support. Together, these improvements in the rotor design allow the induction rotor to attain high speeds without the flux leakage associated with conventional high speed induction rotors in which the conductor slots are closed using the same ferromagnetic material as the main portion of the laminations.

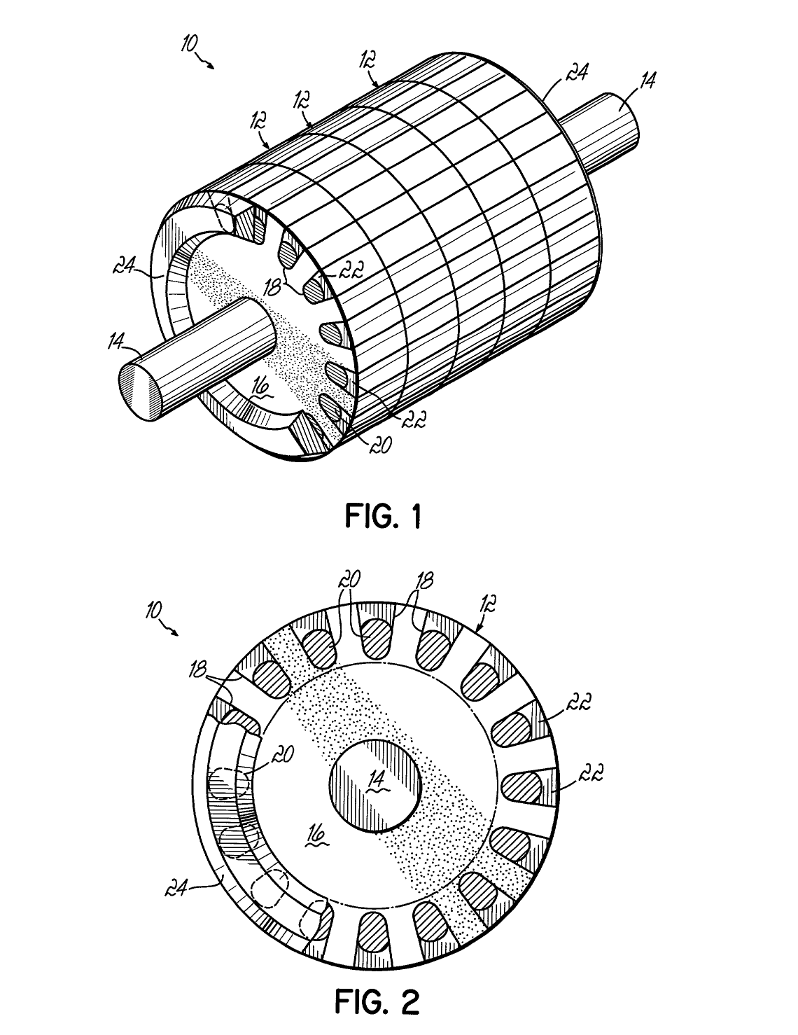

With reference to the Figures in which like numerals are used throughout to represent like parts, FIGS. 1 and 2 depict in perspective view and plan view, respectively, a powder metal rotor assembly 10 of the present invention having a plurality of powder metal composite disks 12 stacked along a shaft 14, each disk 12 having a magnetically conducting segment 16 and a plurality of slots or slot openings 18 aligned from one disk 12 to another along the length of the shaft 14. Within each slot 18 is a conductor 20 enclosed by a magnetically non-conducting segment 22. Thus, each slot 18 receives a conductor 20 in a radially inner portion of the slot 18, and a radially outer portion of the slot 18 comprises the non-conducting segment 22 such that the conductors 20 are embedded within the rotor assembly 10. At each end of the rotor assembly 10 is an end ring 24, which end rings 24 are integral with the conductors 20. In one embodiment of the present invention, the end rings 24 are cast together with the conductors 20. In an alternative embodiment of the present invention, the conductors 20 are first inserted into the slot openings 18, and then the end rings 24 are placed at either end of the assembly 10 and the conductors 20 are affixed to the end rings by any suitable means. As may be appreciated by one skilled in the art, the end rings 24 may include molded fan blades (not shown).

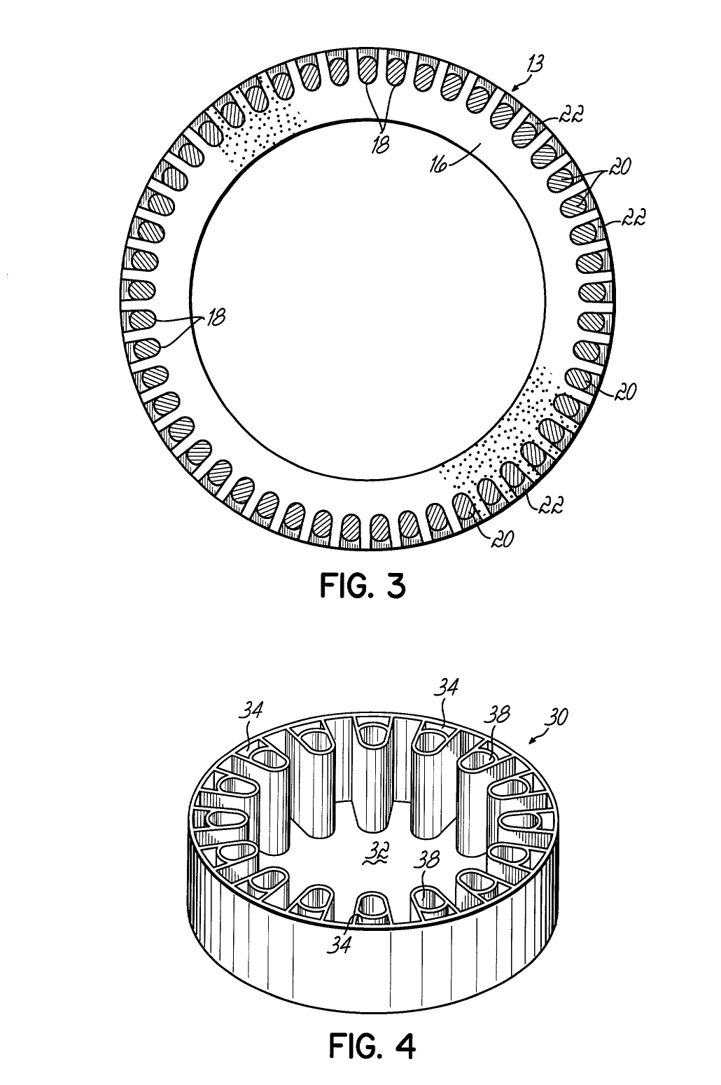

FIG. 3 depicts an embodiment of a high conductor count composite powder metal ring 13, which could be used, for example, in an automotive integral starter motor-alternator. Similarly to FIGS. 1 and 2, ring 13 comprises a magnetically conducting segment 16, but in this ring embodiment, the annular width of segment 16 is smaller than that of the disk embodiments. Ring 13 further comprises a plurality of slot openings 18, and the number of slot openings 18 is greater than the number for the disk embodiment of FIGS. 1 and 2, although this need not necessarily be the case in practice. Each slot opening 18 contains a conductor 20 enclosed by a magnetically non-conducting segment 22.

While FIGS. 1-3 depict various embodiments for induction rotors, it should be appreciated that numerous other embodiments exist having any number of slot openings. One skilled in the art is capable of determining the appropriate number of conductors needed for a particular application. Thus, the invention should not be limited to the particular embodiments shown in FIGS. 1-3. It should be further understood that each embodiment described as a disk could be formed as a ring, which is generally understood to have a smaller annular width and larger inner diameter than a disk. Thus, the term disk used throughout the description of the invention and in the claims hereafter is hereby defined to include a ring. Further, the term disk includes solid disks. The aperture in the center of the disk that receives the rotor shaft may be later formed, for example, by machining.

The present invention further provides a method for fabricating composite powder metal disks or rings for assembling into a rotor for an induction machine. To this end, and in accordance with the present invention, a disk-shaped die is provided having discrete regions in a pattern corresponding to the desired rotor magnetic configuration. One discrete region is filled with a soft ferromagnetic powder metal to ultimately form the magnetically conducting segment of the rotor, and a plurality of discrete regions are filled with non-ferromagnetic powder metal to ultimately form the magnetically non-conducting segments of the rotor. Inserts may be used to form spaces in which the conductors may later be cast or inserted. The powder metals are pressed in the die to form a compacted powder metal disk. This compacted powder metal is then sintered to form a single-piece powder metal disk or lamination having discrete regions of magnetically conducting and non-conducting materials of high structural stability. The pressing and sintering process results in a magnetically conducting segment having a density of at least 95% of theoretical density and non-conducting segments having a density of at least 85% of theoretical density.

In one embodiment of the present invention, the first and second regions in the die are filled concurrently with the two powder metals, which are then concurrently pressed and sintered. In another embodiment of the present invention, the two regions are filled sequentially with the powder metal being pressed and then sintered after each filling step. In other words, one powder metal is filled, pressed and sintered, and then the second powder metal is filled and the entire assembly is pressed and sintered.

The pressing of the filled powder metal may be accomplished by uniaxially pressing the powder in a die, for example at a pressure of about 45-50 tsi. It should be understood that the pressure needed is dependent upon the particular powder metal materials that are chosen. In a further embodiment of the present invention, the pressing of the powder metal involves heating the die to a temperature in the range of about 275° F. (135° C.) to about 290° F. (143° C.), and heating the powders within the die to a temperature about 175° F. (79° C.) to about 225° F. (107° C.).

In an embodiment of the present invention, the sintering of the pressed powder comprises heating the compacted powder metal to a first temperature of about 1400° F. (760° C.) and holding at that temperature for about one hour. Generally, the powder metal includes a lubricating material, such as a plastic, on the particles to increase the strength of the material during compaction. The internal lubricant reduces particle-to-particle friction, thus allowing the compacted powder to achieve a higher green strength after sintering. The lubricant is then burned out of the composite during this initial sintering operation, also known as a de-lubrication or delubing step. A delubing for one hour is a general standard practice in the industry and it should be appreciated that times above or below one hour are sufficient for the purposes of the present invention if delubrication is achieved thereby. Likewise, the temperature may be varied from the general industry standard if the ultimate delubing function is performed thereby. After delubing, the sintering temperature is raised to a full sintering temperature, which is generally in the industry about 2050° F. (1121° C.). During this full sintering, the compacted powder shrinks, and particle-to-particle bonds are formed, generally between iron particles. Standard industry practice involves full sintering for a period of one hour, but it should be understood that the sintering time and temperature may be adjusted as necessary. The sintering operation may be performed in a vacuum furnace, and the furnace may be filled with a controlled atmosphere, such as argon, nitrogen, hydrogen or combinations thereof. Alternatively, the sintering process may be performed in a continuous belt furnace, which is also generally provided with a controlled atmosphere, for example a hydrogen/nitrogen atmosphere such as 75% H_{2/25}% N₂. Other types of furnaces and furnace atmospheres may be used within the scope of the present invention as determined by one skilled in the art.

For the purposes of illustrating the method of the present invention, FIGS. 4-8 depict die inserts, hopper configurations and pressing techniques that may be used to achieve the concurrent filling or sequential filling of the powder metals and subsequent compaction to form the composite powder metal disks of the present invention. It is to be understood, however, that these illustrations are merely examples of possible methods for carrying out the present invention.

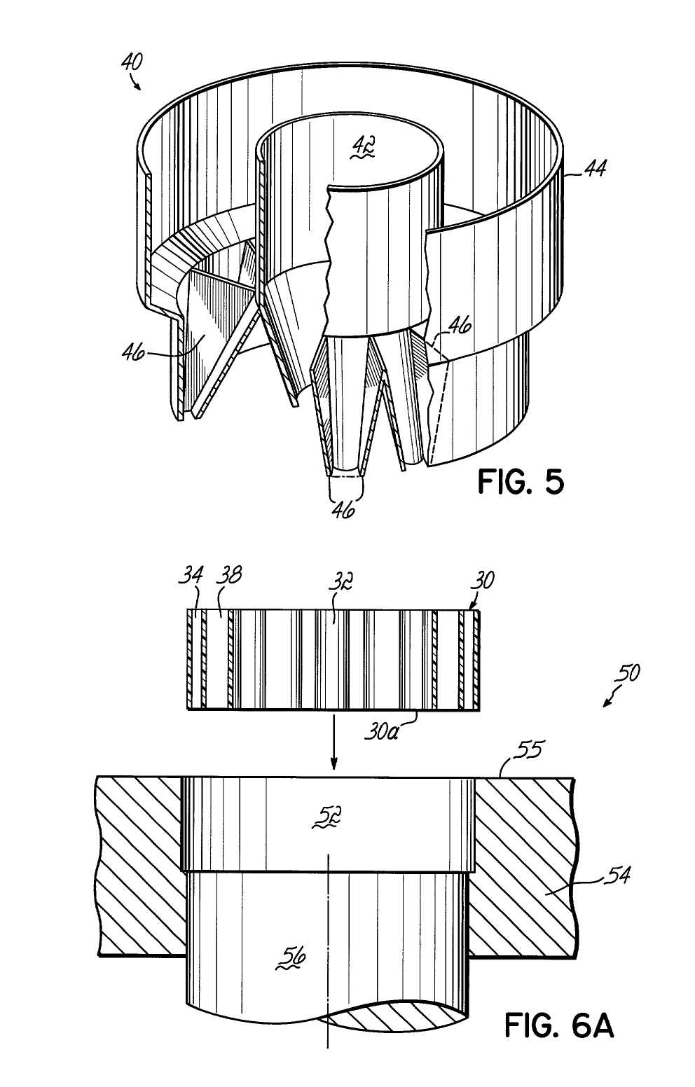

FIG. 4 depicts a die insert 30 that may be placed within a die cavity to produce the powder metal disk 12 of FIGS. 1 and 2. The two powder metals are filled concurrently or sequentially into the separate insert cavities 32, 34. Dummy inserts (not shown) may be placed in cavities 38 for forming spaces in which the conductors 20 may later be cast or inserted. Then the insert 30 is removed. By way of example only, FIG. 5 depicts a hopper assembly 40 that may be used to fill the insert 30 of FIG. 4 with the powder metals. In this assembly 40, an inner bowl 42 is provided for forming the magnetically conducting segment 16 of the composite part or metal disk 12 of FIGS. 1 and 2. To produce the disk 12 of FIGS. 1 and 2, the inner bowl 42 is adapted to hold and deliver the ferromagnetic powder metal. An outer bowl 44 is positioned around the inner bowl 42 and comprises a plurality of chutes 46 for delivering powder metal to form the magnetically non-conducting segments 22 at the slot openings 18. To produce the disk 12 of FIGS. 1 and 2, the outer bowl 44 is adapted to hold and deliver the non-ferromagnetic powder metal. This dual hopper assembly 40 enables either concurrent or sequential filling of the die insert of FIG. 4.

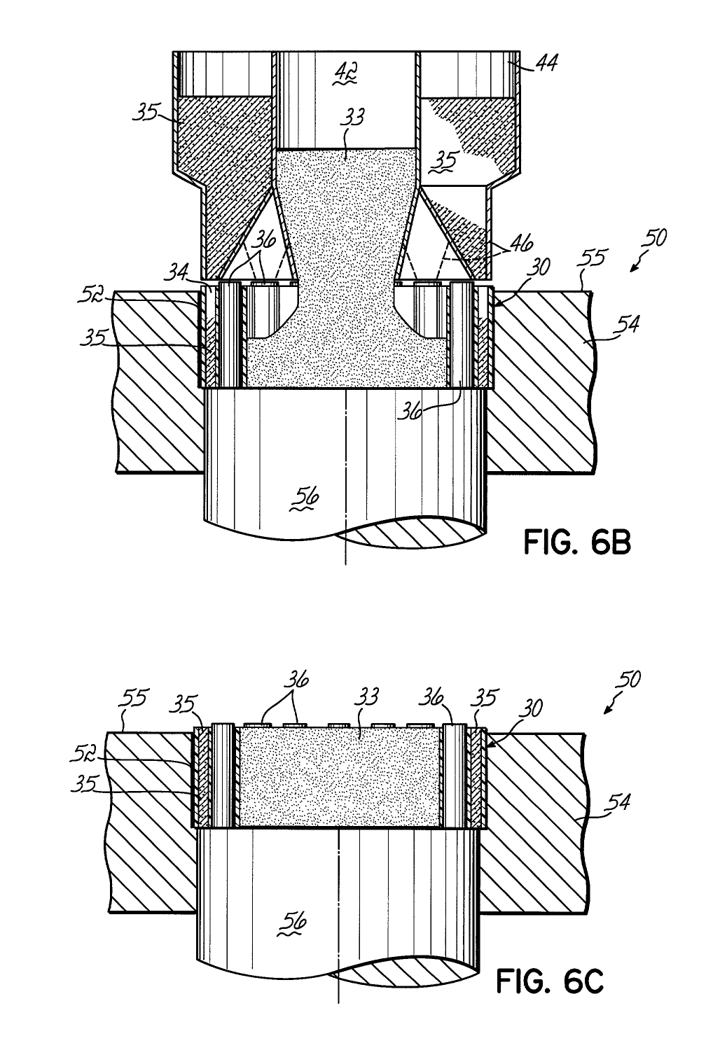

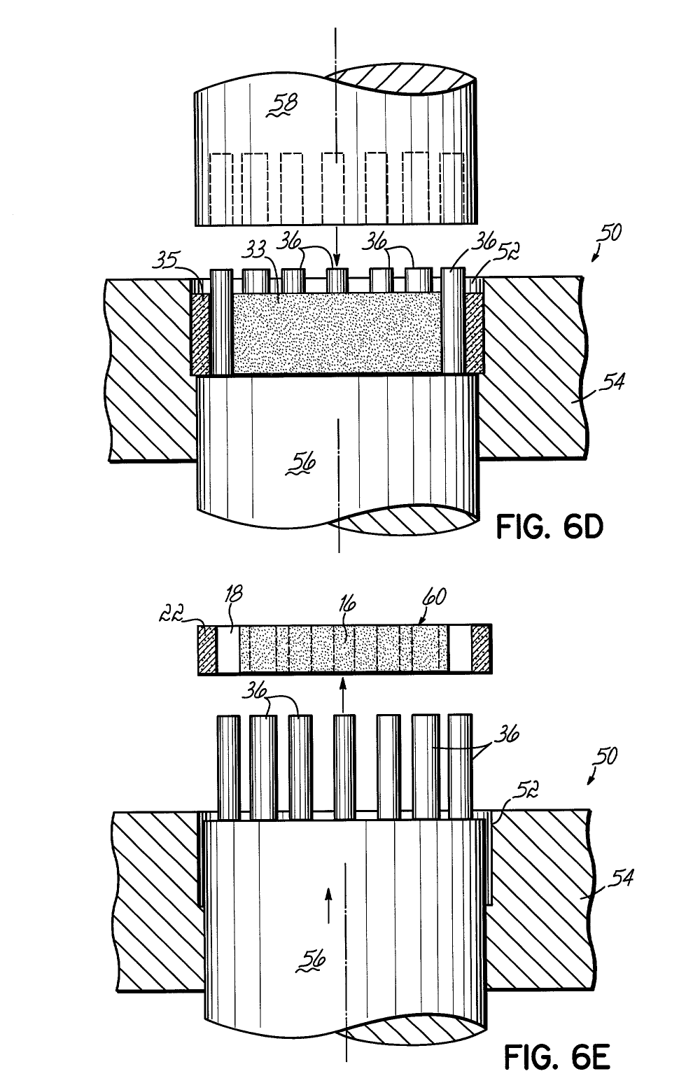

FIGS. 6A-6E depict schematic views in partial cross-section of how the die insert 30 of FIG. 4 and the hopper assembly 40 of FIG. 5 can be used with an uniaxial die press 50 to produce the composite powder metal disk 12 of FIG. 2. In this method, the insert 30 is placed within a cavity 52 in the die 54, as shown in FIG. 6A, with a lower punch 56 of the press 50 abutting the bottom 30a of the insert 30. In this embodiment, dummy inserts 36 are placed in each cavity 38 to serve as space makers for subsequent casting or insertion of conductors 20. The hopper assembly 40 is placed over the insert 30 and the powder metals 33, 35 are filled into the insert cavities 32, 34, concurrently or sequentially, as shown in FIG. 6B. The hopper assembly 40 is then removed, leaving a filled insert 30 in the die cavity 52, as shown in FIG. 6C. Then the insert 30 is lifted out of the die cavity 52, which causes some settling of the powder, as seen in FIG. 6D. The upper punch 58 of the press 50 is then lowered down upon the powder-filled die cavity 52, as shown by the arrow in FIG. 6D, to uniaxially press the powders in the die cavity 52. The final composite part 60 is ejected from the die cavity 52 by raising the lower punch 56 and the dummy inserts are removed. The part 60 is then transferred to a sintering furnace (not shown). Where the filling is sequential, the first powder is poured into either the inner bowl 42 or outer bowl 44, and a specially configured upper punch 58 is lowered so as to press the filled powder, and the partially filled and compacted insert (not shown) is sintered. The second fill is then effected and the insert 30 removed for pressing, ejection and sintering of the complete part 60.

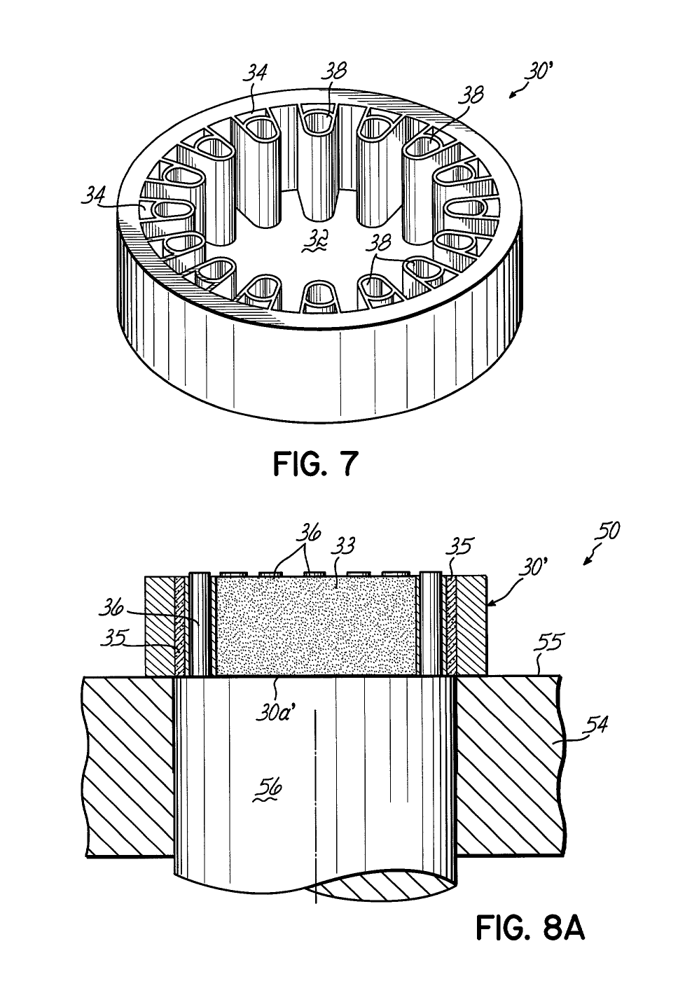

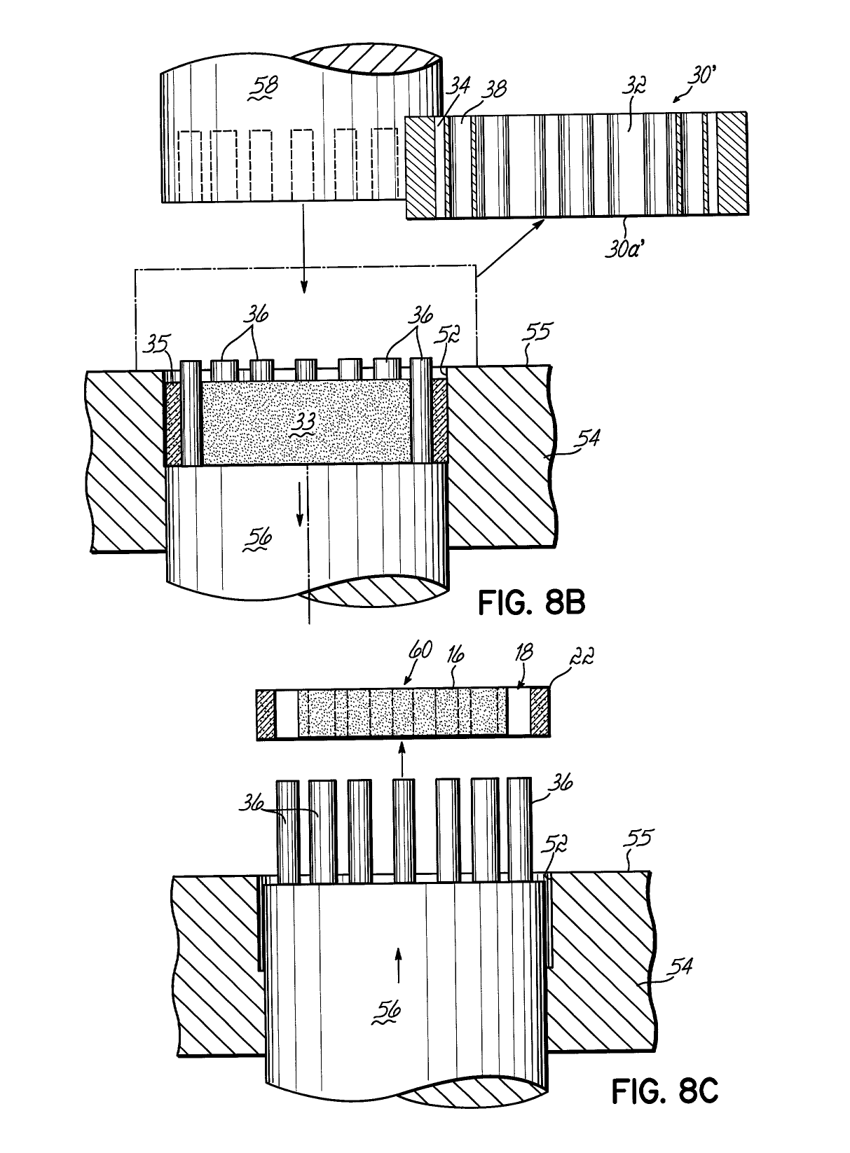

FIG. 7 depicts an alternative die insert 30′ that may be placed on a top surface 55 of the die 54 over the die cavity 52 to again form the powder metal disk 12 depicted in FIGS. 1 and 2. FIGS. 8A-8C show the method for using the insert 30′ of FIG. 7. The insert is set on top surface 55 of the die 54 over the cavity 52 with the lower punch 56 in the ejection position, as shown in FIG. 8A. The powder metals 33,35 are then filled into the insert 30′, either concurrently or sequentially, as shown in FIG. 6B, and dummy inserts 36 are placed in cavities 38. The lower punch 56 is then lowered to the fill position. The lowering of the punch 56 forms a vacuum which pulls the powder metals 33, 35 and dummy inserts 36 out of the bottom 30a′ of the insert 30′ and into the die cavity 52, as shown in FIG. 8B. The insert 30′ is then removed from the top surface 55 of the die 54, and the upper punch 58 is lowered into the die cavity 52 to compact the powder metals 33, 35. The lower punch 56 is then raised to eject the final composite part 60, as shown in FIG. 8C, and the dummy inserts are removed. The part 60 is then transferred to a sintering furnace (not shown). Where the filling is sequential, additional dummy placement segments (not shown) may be used for the first filling/pressing/sintering sequence which can then be removed to effect the filling of the second powder metal.

In one embodiment of the present invention, pneumatic air hammers or tappers (not shown) may be placed on, in, or around the inserts 30, 30′ used in either the method depicted in FIGS. 6A-6E or the method depicted in FIGS. 8A-8C. The vibrating of the insert 30, 30′ enables the powder metal 33, 35 to flow out of the insert 30, 30′ with greater ease as the insert 30, 30′ is removed, and further enables a greater tap density. In another embodiment of the present invention, a dry lube is sprayed or added to the inside of the insert cavities 32, 34 used in either of those methods. Again, this dry lube helps to improve the flow of the powder metals 33, 35 out of the insert 30, 30′. In yet another embodiment of the present invention, heaters and thermocouples (not shown) may be used in conjunction with the insert 30, 30′. The heat keeps the powder warm, if warm compaction is being optimized, and again allows the powder metals 33, 35 to more easily flow out of the insert 30, 30′.

It should be further understood that while the methods shown and described herein are discussed with respect to forming a solid composite disk with the aperture being machined after compaction or sintering, the composite part may initially be formed as a disk with an aperture in the center for receiving the shaft of a rotor assembly.

While the present invention has been illustrated by the description of embodiments thereof, and while the embodiments have been described in considerable detail, they are not intended to restrict or in any way limit the scope of the appended claims to such detail. Additional advantages and modifications will readily appear to those skilled in the art. For example, variations in the hopper assembly, filling method and die inserts may be employed to achieve a composite powder metal disk of the present invention, and variations in the magnetic configuration of the disks other than that shown in the Figures herein are well within the scope of the present invention. The invention in its broader aspects is therefore not limited to the specific details, representative apparatuses and methods and illustrative examples shown and described. Accordingly, departures may be made from such details without departing from the scope or spirit of applicant's general inventive concept.

What is claimed is:

1. A method of making a powder metal rotor for an induction machine, the method comprising:
filling a first region of a disk-shaped die with a soft ferromagnetic powder metal to form a pattern of a plurality of equally spaced axially extending slots adjacent an exterior circumferential surface of the disk-shaped die;
filling a plurality of discrete second regions of the die in a radially outer portion of each slot adjacent the exterior circumferential surface with a non-ferromagnetic powder metal, thereby forming closed slot openings;
pressing the powders in the die to form a compacted powder metal disk;
sintering the compacted powder metal disk to form a composite powder metal disk having a magnetically conducting segment and a plurality of magnetically non-conducting segments enclosing slot openings.

2. The method of claim 1, wherein the first and second regions are filled concurrently.

3. The method of claim 1, wherein the first and second regions are filled sequentially with the powder metal being pressed and sintered after each filling step.

4. The method of claim 1, wherein the soft ferromagnetic powder metal is Ni, Fe, Co or an alloy thereof.

5. The method of claim 1, wherein the soft ferromagnetic powder metal is a high purity iron powder with a minor addition of phosphorus.

6. The method of claim 1, wherein the non-ferromagnetic powder metal is an austenitic stainless steel.

7. The method of claim 1, wherein the non-ferromagnetic powder metal is an AISI 8000 series steel.

8. The method of claim 1, wherein the pressing comprises uniaxially pressing the powders in the die.

9. The method of claim 1, wherein the pressing comprises pre-heating the powders and pre-heating the die.

10. The method of claim 1, wherein, after the pressing, the compacted powder metal disk is de-lubricated at a first temperature, followed by sintering at a second temperature greater than the first temperature.

11. The method of claim 1, wherein the sintering is performed in a vacuum furnace having a controlled atmosphere.

12. The method of claim 1, wherein the sintering is performed in a belt furnace having a controlled atmosphere.

13. The method of claim 1 further comprising stacking a plurality of the composite powder metal disks axially along a shaft with the slot openings aligned and casting a conductor into each slot opening of the aligned composite powder metal disks and casting end rings at each axial end of the stacked disks to form a powder metal rotor assembly.

14. The method of claim 13, wherein the conductor comprises aluminum.

15. The method of claim 1, further comprising stacking a plurality of the composite powder metal disks axially along a shaft with the slot openings aligned and providing a conductor bar in each slot opening of the aligned composite powder metal disks to form a powder metal rotor assembly.

16. The method of claim 15, wherein the conductor bars comprise copper.

17. A method of making a powder metal rotor for an induction machine, the method comprising:
filling a first region of a disk-shaped die with a soft ferromagnetic powder metal to form a pattern of a plurality of equally spaced axially extending slots adjacent an exterior circumferential surface of the disk-shaped die;
pressing the soft ferromagnetic powder metal in the die to form a compacted magnetically conducting segment;
sintering the compacted magnetically conducting segment;
filling a plurality of discrete second regions of the die in a radially outer portion of each slot adjacent the exterior circumferential surface with a non-ferromagnetic powder metal, thereby forming closed slot openings;
pressing the non-ferromagnetic powder metal in the die to form a plurality of compacted magnetically non-conducting segments enclosing slot openings; and
sintering the compacted magnetically non-conducting segments and the compacted and sintered conducting segment to form a composite powder metal disk having the conducting segment and the plurality of magnetically non-conducting segments.

18. The method of claim 17, wherein the ferromagnetic powder metal is Ni, Fe, Co or an alloy thereof.

19. The method of claim 17, wherein the soft ferromagnetic powder metal is a high purity iron powder with a minor addition of phosphorus.

20. The method of claim 17, wherein the non-ferromagnetic powder metal is an austenitic stainless steel.

21. The method of claim 17, wherein the non-ferromagnetic powder metal is an AISI 8000 series steel.

22. The method of claim 17, wherein each pressing comprises uniaxially pressing the powder in the die.

23. The method of claim 17, wherein each pressing comprises pre-heating the powder and pre-heating the die.

24. The method of claim 17, wherein, after each pressing, the compacted segments are de-lubricated at a first temperature, followed by sintering at a second temperature greater than the first temperature.

25. The method of claim 17, wherein each sintering is performed in a vacuum furnace having a controlled atmosphere.

26. The method of claim 17, wherein each sintering is performed in a belt furnace having a controlled atmosphere.

27. The method of claim 17 further comprising stacking a plurality of the composite powder metal disks axially along a shaft with the slot openings aligned and casting a conductor into each slot opening of the aligned composite powder metal disks and casting end rings at each axial end of the stacked disks to form a powder metal rotor assembly.

28. The method of claim 27, wherein the conductor comprises aluminum.

29. The method of claim 17 further comprising stacking a plurality of the composite powder metal disks axially along a shaft with the slot openings aligned and providing a conductor bar in each slot opening of the aligned composite powder metal disks to form a powder metal rotor assembly.

30. The method of claim 29, wherein the conductor bars comprise copper.

31. A method of making a powder metal rotor for an induction machine, the method comprising:
concurrently filling a first region of a disk-shaped die with a soft ferromagnetic powder metal to form a pattern of a plurality of equally spaced axially extending slots adjacent an exterior circumferential surface of the disk-shaped die and in a plurality of discrete second regions of the die in a radially outer portion of each slot adjacent the exterior circumferential surface with a non-ferromagnetic powder metal, thereby forming closed slot openings;
concurrently pressing the powders in the die to form a compacted powder metal disk; and
sintering the compacted powder metal disk to form a composite powder metal disk having a magnetically conducting segment and a plurality of magnetically non-conducting segments.

32. The method of claim 31, wherein the soft ferromagnetic powder metal is Ni, Fe, Co or an alloy thereof.

33. The method of claim 31, wherein the soft ferromagnetic powder metal is a high purity iron powder with a minor addition of phosphorus.

34. The method of claim 31, wherein the non-ferromagnetic powder metal is an austenitic stainless steel.

35. The method of claim 31, wherein the non-ferromagnetic powder metal is an AISI 8000 series steel.

36. The method of claim 31, wherein the pressing comprises uniaxially pressing the powders in the die.

37. The method of claim 31, wherein the pressing comprises pre-heating the powders and pre-heating the die.

38. The method of claim 31, wherein, after the pressing, the compacted powder metal disk is de-lubricated at a first temperature, followed by sintering at a second temperature greater than the first temperature.

39. The method of claim 31, wherein the sintering is performed in a vacuum furnace having a controlled atmosphere.

40. The method of claim 31, wherein the sintering is performed in a belt furnace having a controlled atmosphere.

41. The method of claim 31 further comprising stacking a plurality of the composite powder metal disks axially along a shaft with the slot openings aligned and casting a conductor into each slot opening of the aligned composite powder metal disks and casting end rings at each axial end of the stacked disks to form a powder metal rotor assembly.

42. The method of claim 41, wherein the conductor comprises aluminum.

43. The method of claim 31 further comprising stacking a plurality of the composite powder metal disks axially along a shaft with the slot openings aligned and providing a conductor bar in each slot opening of the aligned composite powder metal disks to form a powder metal rotor assembly.

44. The method of claim 43, wherein the conductor bars comprise copper.

45. A powder metal disk for a rotor assembly in an induction machine, the disk comprising a magnetically conducting segment of pressed and sintered soft ferromagnetic powder metal and a plurality of equally spaced axially extending slots adjacent an exterior circumferential surface of the disk, each slot adapted to receive a conductor in a radially inner portion thereof, and a plurality of magnetically non-conducting segments of pressed and sintered non-ferromagnetic powder metal in a radially outer portion of each of the slots adjacent the exterior circumferential surface and adapted to enclose the conductor within the slot.

46. The disk of claim 45, wherein the soft ferromagnetic powder metal is Ni, Fe, Co or an alloy thereof.

47. The disk of claim 45, wherein the soft ferromagnetic powder metal is a high purity iron powder with a minor addition of phosphorus.

48. The disk of claim 45, wherein the non-ferromagnetic powder metal is an austenitic stainless steel.

49. The disk of claim 45, wherein the non-ferromagnetic powder metal is an AISI 8000 series steel.

50. A powder metal disk for a rotor assembly in an induction machine, the disk comprising a magnetically conducting segment of pressed and sintered soft ferromagnetic powder metal and a plurality of equally spaced axially extending slots adjacent an exterior circumferential surface of the disk, each slot containing a conductor in a radially inner portion thereof and a magnetically non-conducting segment of pressed and sintered non-ferromagnetic powder metal in a radially outer portion thereof adjacent the exterior circumferential surface, the magnetically non-conducting segment enclosing the conductor within the slot.

51. The disk of claim 50, wherein the soft ferromagnetic powder metal is Ni, Fe, Co or an alloy thereof.

52. The disk of claim 50, wherein the soft ferromagnetic powder metal is a high purity iron powder with a minor addition of phosphorus.

53. The disk of claim 50, wherein the non-ferromagnetic powder metal is an austenitic stainless steel.

54. The disk of claim 50, wherein the non-ferromagnetic powder metal is an AISI 8000 series steel.

55. A powder metal rotor assembly for an induction machine, comprising:
a shaft; and
a plurality of powder metal composite disks axially stacked along and affixed to the shaft in an aligned magnetic pattern, each disk made of a magnetically conducting segment of pressed and sintered soft ferromagnetic powder metal and a plurality of equally spaced axially extending slots adjacent an exterior circumferential surface of the disk, each slot adapted to receive a conductor in a radially inner portion thereof, and a plurality of magnetically non-conducting segments of pressed and sintered non-ferromagnetic powder metal in a radially outer portion of each of the slots adjacent the exterior circumferential surface and adapted to enclose the conductor within the slot.

56. The assembly of claim 55, wherein the soft ferromagnetic powder metal is Ni, Fe, Co or an alloy thereof.

57. The assembly of claim 55, wherein the soft ferromagnetic powder metal is a high purity iron powder with a minor addition of phosphorus.

58. The assembly of claim 55, wherein the non-ferromagnetic powder metal is an austenitic stainless steel.

59. The assembly of claim 55, wherein the non-ferromagnetic powder metal is an AISI 8000 series steel.

60. The assembly of claim 55 further comprising a pair of aluminum axial end rings positioned in opposing relation at each axial end of the stacked and aligned plurality of disks, and a conductor of cast aluminum in each of the slots, the conductors integral with the end rings.

61. The assembly of claim 55 further comprising a pair of copper axial end rings positioned in opposing relation at each axial end of the stacked and aligned plurality of disks, and a copper bar conductor in each of the slots, the conductors affixed to the end rings.
